(19) United States
(12) Patent Application Publication
(10) Pub. No.: US 2002/0137655 A1
(43) Pub. Date: Sep. 26, 2002

(54) Use of haloperoxidase, peroxide and carboxylic acid

(75) Inventors: Charlotte Johansen, Holte (DK); Michael Skovgaard Nielsen, Copenhagen O (DK); Palle Schneider, Ballerup (DK); Jeanette Theil Johansen, Vaerloese (DK)

Correspondence Address: NOVOZYMES NORTH AMERICA, INC., 500 FIFTH AVENUE, SUITE 1600, NEW YORK, NY, 10110, US

(73) Assignee: Novozymes A/S, Bagsvaerd (DK)

(21) Appl. No.: 10/023,039

(22) Filed: Dec. 12, 2001

Related U.S. Application Data
(60) Provisional application No. 60/261,938, filed on Jan. 16, 2001.

(30) Foreign Application Priority Data
Dec. 15, 2000 (DK) 2000 01889

(51) Int. Cl. C11D 7/18

(52) U.S. Cl. 510/392; 510/305

(57) ABSTRACT

Haloperoxidases are capable of exhibiting excellent oxidizing, bleaching, and antimicrobial activity, when combined with carboxylic acids. Accordingly, the invention provides an enzymatic composition comprising a haloperoxidase, a source of hydrogen peroxide, and a source of a carboxylic acid.

### CROSS-REFERENCE TO RELATED APPLICATIONS

This application claims, under 35 U.S.C. 119, priority of Danish application no. PA 2000 filed Dec. 15, 2000, and the benefit of U.S. provisional application no. 60/261,938, filed Jan. 20, 2001, the contents of which are fully incorporated herein by reference.

### FIELD OF THE INVENTION

The invention relates to enzymatic compositions comprising a haloperoxidase enzyme, hydrogen peroxide and a carboxylic acid.

### BACKGROUND

Haloperoxidases are known to be able to oxidize halides, and this effect has been utilized in several disclosed compositions and methods comprising haloperoxidases, hydrogen peroxide and halides.

### SUMMARY OF THE INVENTION

We have found that haloperoxidases are capable of exhibiting excellent oxidizing, bleaching, and antimicrobial activity, when combined with carboxylic acids.

Accordingly, there is provided an enzymatic composition, comprising (a) a haloperoxidase; (b) a source of hydrogen peroxide; and (c) a source of a carboxylic acid.

In an embodiment the composition contains less than 1 mM of a halide, and in another embodiment the composition contains less than 1 mM of an amino acid.

In a second aspect, there is provided an antimicrobial composition comprising (a) a haloperoxidase; (b) a source of hydrogen peroxide; (c) a source of a carboxylic acid; and (d) an enhancing agent.

In further aspects of the invention, there are provided methods for oxidizing an organic compound, for killing or inhibiting microbial cells, and for modifying the color associated with a dye or colored compound, by using the enzymatic composition of the invention.

In yet another aspect, there is provided a detergent composition comprising the enzymatic composition and a surfactant.

### DETAILED DESCRIPTION

In the context of the present invention the terms “antimicrobial” and “biocidal” are intended to mean that there is a bactericidal and/or a bacteriostatic and/or fungicidal and/or fungistatic effect and/or a virucidal effect, wherein

The term “bactericidal” is to be understood as capable of killing bacterial cells.

The term “bacteriostatic” is to be understood as capable of inhibiting bacterial growth, i.e. inhibiting growing bacterial cells.

The term “fungicidal” is to be understood as capable of killing fungal cells.

The term “fungistatic” is to be understood as capable of inhibiting fungal growth, i.e. inhibiting growing fungal cells.

The term “virucidal” is to be understood as capable of inactivating virus.

The term “microbial cells” denotes bacterial cells, fungal cells or algae, and the term “microorganism” denotes a fungus (including yeasts) or a bacterium.

In the context of the present invention the term “inhibiting microbial cells” is intended to mean that the cells are in the non-growing state, i.e., that they are essentially not able to propagate.

The term “hard surface” as used herein relates to any surface, which is essentially non-permeable for microorganisms. Examples of hard surfaces are surfaces made from metal, e.g., stainless steel, plastics, rubber, board, glass, wood, paper, textile, concrete, rock, marble, gypsum and ceramic materials which optionally may be coated, e.g., with paint, enamel and the like. The hard surface can also be a process equipment, e.g., a cooling tower, an osmotic membrane, a water treatment plant, a dairy, a food processing plant, a chemical plant, a pharmaceutical process plant, a pulp and paper plant or an oil processing plant. Accordingly, the composition according to the present invention is useful in a conventional cleaning-in-place (C-I-P) system.

Haloperoxidases

The haloperoxidases suitable for being incorporated in the composition of the invention include chloro-, bromo- and iodo-peroxidases. Haloperoxidases form a class of enzymes, which are able to oxidize halides (Cl—, Br—, I—) in the presence of hydrogen peroxide or a hydrogen peroxide generating system to the corresponding hypohalous acids according to:

H₂O₂+X—+H+->H₂O+HOX

wherein X— is a halide and HOX is a hypohalous acid.

There are three types of haloperoxidases, classified according to their specificity for halide ions: Chloroperoxidases (E.C. 1.11.1.10) which catalyse formation of hypo-chlorite from chloride ions, hypobromite from bromide ions and hypoiodite from iodide ions; Bromoperoxidases which catalyse formation of hypobromite from bromide ions and hypoiodite from iodide ions; and iodoperoxidases (E.C. 1.11.1.8) which solely catalyze the formation of hypoiodite from iodide ions. Hypoiodite, however, undergoes spontaneous disproportionation to iodine and thus iodine is the observed product. These hypohalite compounds may subsequently react with other compounds forming halogenated compounds.

Haloperoxidases have been isolated from various organisms: mammals, marine animals, plants, algae, lichen, fungi and bacteria. It is generally accepted that haloperoxidases are the enzymes responsible for the formation of halogenated compounds in nature, although other enzymes may be involved.

Haloperoxidases have been isolated from many different fungi, in particular from the fungus group dematiaceous hyphomycetes, such as Caldariomyces, e.g., C. fumago, Alternaria, Curvularia, e.g., C. verruculosa and C. inaequalis, Drechslera, Ulocladium and Botrytis.

Haloperoxidases have also been isolated from bacteria such as Pseudomonas, e.g., P. pyrrocinia and Streptomyces, e.g., S. aureofaciens.

In a preferred embodiment the haloperoxidase is a vanadium haloperoxidase (i.e. a vanadium or vanadate containing haloperoxidase) derivable from Curvularia sp., in particular Curvularia verruculosa and Curvularia inaequalis, such as C. inaequalis CBS 102.42 as described in WO 95/27046, e.g. a vanadium haloperoxidase encoded by the DNA sequence of WO 95/27046, FIG. 2 all of which are incorporated by reference; or C. verruculosa CBS 147.63 or C. verruculosa CBS 444.70 as described in WO 97/04102.

In another preferred embodiment the haloperoxidase is a vanadium containing haloperoxidase, such as a vanadium chloroperoxidase. The vanadium chloroperoxidase may be derivable from a strain selected from Drechslera hartlebii, Dendryphiella salina, Phaeotrichoconis crotalarie and Geniculosporium sp. The vanadium haloperoxidase is more preferably derivable from Drechslera hartlebli (DSM 13444), Dendryphiella salina (DSM 13443), Phaeotrichoconis crotalarie (DSM 13441) and Geniculosporium sp. (DSM 13442).

The concentration of the haloperoxidase is typically in the range of 0.01-100 ppm enzyme protein, preferably 0.05-50 ppm enzyme protein, more preferably 0.1-20 ppm enzyme protein, and most preferably 0.5-10 ppm enzyme protein.

Determination of Haloperoxidase Activity

Microtiter assays are performed by mixing 100 μl of haloperoxidase sample (about 0.2 μg/ml) and 100 μl of 0.3 M sodium phosphate pH 7 buffer-0.5 M potassium bromide-0.008% phenol red, adding the solution to 10 μl of 0.3% H₂O₂, and measuring the absorption at 595 nm as a function of time.

Assays using monochlorodimedone (Sigma M4632, ε=20000 M⁻¹cm⁻¹ at 290 nm) as a substrate are performed as described below. The decrease in absorption at 290 nm is measured as a function of time. Assays are performed in 0.1 M sodium phosphate or 0.1 M sodium acetate, 50 μM monochlorodimedone, 10 mM KBr/KCl, and 1 mM H₂O₂ using a haloperoxidase concentration of about 1 μg/ml. One HU is defined as 1 micromol of monochlorodimedone chlorinated or brominated per minute at pH 5 and 30° C.

Hydrogen Peroxide Sources

According to the invention the hydrogen peroxide needed for the reaction with the haloperoxidase may be achieved in many different ways. It may be hydrogen peroxide or a hydrogen peroxide precursor (for in situ production of hydrogen peroxide), such as, e.g., percarbonate or perborate, or a peroxycarboxylic acid or a salt thereof. Any solid entity which liberates upon dissolution a peroxide which is useable by haloperoxidase can serve as the source of hydrogen peroxide. Compounds which yield hydrogen peroxide upon dissolution in water or an appropriate aqueous based medium include but are not limited to metal peroxides, persulphates, perphosphates, peroxyacids, alkyperoxides, acylperoxides, peroxyesters, urea peroxide. Mixtures of two or more of these substances can also be used.

Another source of hydrogen peroxide may be a hydrogen peroxide generating enzyme system, such as, e.g., an oxidase and its substrate. Useful oxidases may be, e.g., a glucose oxidase, a glycerol oxidase or an amino acid oxidase. Other examples include, but are not limited to, lactate oxidase and lactate, galactose oxidase (see e.g. WO 00/50606) and galactose, and aldose oxidase (see e.g. WO 99/31990) and a suitable aldose.

By studying EC 1.1.3._, EC 1.2.3.₁₃ , EC 1.4.3._, and EC 1.5.3._ or similar classes (under the International Union of Biochemistry), other examples of such combinations of oxidases and substrates are easily recognized by one skilled in the art.

It may be advantageous to use enzymatically generated hydrogen peroxide, since this source results in a relatively low concentration of hydrogen peroxide under the biologically relevant conditions. Low concentrations of hydrogen peroxide result in an increase in the rate of haloperoxidase-catalyzed reaction.

According to the invention the hydrogen peroxide source needed for the reaction with the haloperoxidase may be added in a concentration corresponding to a hydrogen peroxide concentration in the range of from 0.01-1000 mM, preferably in the range of from 0.1-100 mM. The source of hydrogen peroxide may be added at the beginning of or during a process, such as in one of the methods of the invention.

Carboxylic Acid Sources

The carboxylic acid sources suitable for the compositions and methods of the present invention include any carboxylic acid source, which directly or indirectly is capable of making carboxylic acids available. An indirect carboxylic acid source may be a carboxylic acid precursor, such as a carboxylic acid ester, carboxylic acid anhydride or carboxylic acid amide. Preferably the carboxylic acids are water soluble (at least 0.1 mg/L at 20° C.).

In the context of the present invention the term “carboxylic acid” is intended to include any compound containing at least one carboxyl group as described in chapter 19 (Carboxylic Acids) of Morrison and Boyd: Organic Chemistry, fourth edition, Allyn and Bacon Inc.

Carboxyl group:

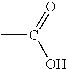

Preferably the compound contains 1, 2, 3, 4, 5, 6, 7, 8, 9 or 10 carboxyl groups. In an embodiment, the carboxylic acid is a polymer with several carboxyl groups, such as poly(acrylic acid).

The carboxyl group may be in the acidic form (carboxylic acid), or it may be the salt thereof (carboxylate). The cat ion of the salt may be sodium, potassium, ammonium, magnesium or calcium. A compound with more than one carboxyl group may contain both carboxylic acid groups and carboxylate groups.

The carboxyl group may be attached to an alkyl group (aliphatic carboxylic acid) or to an aryl group (aromatic carboxylic acid), or to combinations thereof.

The alkyl group may be a straight or branched, unsaturated or saturated, unsubstituted or substituted chain alkyl having from 1 to 10 carbon atoms; where the substituent group may be located at C₁-C₁₀ and represent any of the following radicals: hydroxy, halogen, formyl, carboxy, carboxy esters, carboxy salts, carbamoyl, sulfo, sulfo esters, sulfo salts, sulfamoyl, nitro, amino, phenyl.

The aryl group may be a unsubstituted or substituted aromatic ring, which may be combined with the above-mentioned alkyl group, and fused to other aromatic rings and/or cyclic rings and/or heterocyclic rings.

Examples of preferred carboxylic acids include:

Formic acid, Acetic acid, Propionic acid, Butyric acid, Valeric acid, Caproic acid, Caprylic acid, Cyclohexanecarboxylic acid, Phenylacetic acid, Benzoic acid, Toluic acid, Chlorobenzoic acid, Bromobenzoic acid, Nitrobenzoic acid, Phtalic acid, Isophtalic acid, Terephtalic acid, Salicylic acid, Sulfosalicylic acid, Hydroxybenzoic acid, Antranilic acid, Aminobenzoic acid, Methoxybenzoic acid, Trimethylacetic acid, Trichloroacetic acid, Citric acid, Lactic acid, Cinnamic acid, Gluconic acid, Glucuronic acid, Glutaric acid, 3,3-Dimethylglutaric acid (DMG), dimethylmalonic acid, Maleic acid, Succinic acid, Aminocyclohexanecarboxylic acid and Picolinic acid.

In an embodiment the carboxylic acid source is not an alpha amino acid.

According to the invention the carboxylic acid source needed for the reaction with the haloperoxidase may be added in a concentration corresponding to a carboxylic acid concentration in the range of from 0.001-1000 mM, preferably in the range of from 0.01-500 mM, more preferably in the range of from 0.1-200 mM, most preferably in the range of from 0.5-100 mM, and in particular in the range of from 1-50 mM.

Composition

The present invention provides an enzymatic composition, comprising a haloperoxidase, a source of hydrogen peroxide, and a source of a carboxylic acid.

In an embodiment, the composition contains less than 1 mM (preferably less than 0.5 mM, more preferably less than 0.1 mM, most preferably less than 0.05 mM, and in particular less than 0.01 mM) of a halide, such as chloride, bromide or iodide. In another embodiment, the composition contains less than 1 mM (preferably less than 0.5 mM, more preferably less than 0.1 mM, most preferably less than 0.05 mM, and in particular less than 0.01 mM) of an amino acid, such as a naturally occurring amino acid or an artificial amino acid or an alpha amino acid. In another embodiment the composition does not contain an amino acid, such as an alpha amino acid.

The composition may be formulated as a solid, liquid, gel or paste.

When formulated as a solid all components may be mixed together, e.g., as a powder, a granulate or a gelled product.

When other than dry form compositions are used and even in that case, it is preferred to use a two-part formulation system having the enzyme(s) separate from the rest of the composition.

The composition of the invention may further comprise auxiliary agents such as wetting agents, thickening agents, buffers, stabilisers, perfume, colourants, fillers and the like.

Useful wetting agents are surfactants, i.e., non-ionic, anionic, amphoteric or zwitterionic surfactants.

The composition of the invention may be a concentrated product or a ready-to-use product. In use, the concentrated product is typically diluted with water to provide a medium having an effective enzymatic activity, applied to the object to be treated, and allowed to react with the dyes, organic compounds, microorganisms, or the like, which are present on or in the object.

The pH of an aqueous solution of the composition is in the range of from pH 2 to 11, preferably in the range of from pH 3 to 10, more preferably in the range of from pH 4 to 9, and most preferably in the range of from pH 5 to 8.

The composition may also include an enhancing agent.

The enhancing agent may be selected from the group consisting of aliphatic, cyclo-aliphatic, heterocyclic or aromatic compounds containing the moiety >N—OH. In a preferred embodiment of the invention the enhancing agent is a compound of the general formula I:

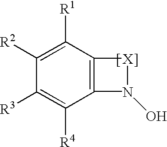

wherein R¹, R², R³, R⁴ are individually selected from the group consisting of hydrogen, halogen, hydroxy, formyl, carboxy and salts and esters thereof, amino, nitro, C₁₋₁₂-alkyl, C₁₋₆-alkoxy, carbonyl(C₁₋₁₂-alkyl), aryl, in particular phenyl, sulfo, aminosulfonyl, carbamoyl, phosphono, phosphonooxy, and salts and esters thereof, wherein the R¹, R², R³, R⁴ may be substituted with R⁵, wherein R⁵ represents hydrogen, halogen, hydroxy, formyl, carboxy and salts and esters thereof, amino, nitro, C₁₋₁₂-alkyl, C₁₋₆-alkoxy, carbonyl(C₁₋₁₂-alkyl), aryl, in particular phenyl, sulfo, aminosulfonyl, carbamoyl, phosphono, phosphonooxy, and salts and esters thereof;

[X] represents a group selected from (—N═N—), (—N═CR⁶—)ₘ, (—CR⁶═N—)ₘ, (—CR⁷═CR⁸—)ₘ, , (—CR⁶═N—NR⁷—), (—N═N—CHR⁶—), (—N═CR⁶—NR⁷—), (—N═CR⁶—CHR⁷—), (—CR⁶═N—CHR⁷—), (—CR⁶═CR⁷—NR⁸—), and (—CR⁶═CR⁷—CHR⁸—), wherein R⁶, R⁷, and R⁸ independently of each other are selected from H, OH, NH₂, COOH, SO₃H, C₁₋₆-alkyl, NO₂, CN, Cl, Br, F, CH₂OCH₃, OCH₃, and COOCH₃; and m is 1 or 2.

The term “C₁₋ₙ-alkyl” wherein n can be from 2 through 12, as used herein, represent a branched or straight alkyl group having from one to the specified number of carbon atoms. Typical C₁₋₆-alkyl groups include, but are not limited to, methyl, ethyl, n-propyl, iso-propyl, butyl, iso-butyl, sec-butyl, tert-butyl, pentyl, iso-pentyl, hexyl, iso-hexyl and the like.

In a more preferred embodiment of the invention the enhancing agent is a compound of the general formula II:

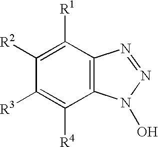

wherein R¹, R², R³, R⁴ are individually selected from the group consisting of hydrogen, halogen, hydroxy, formyl, carboxy and salts and esters thereof, amino, nitro, C₁₋₁₂-alkyl, C₁₋₆-alkoxy, carbonyl(C₁₋₁₂-alkyl), aryl, in particular phenyl, sulfo, aminosulfonyl, carbamoyl, phosphono, phosphonooxy, and salts and esters thereof, wherein the R¹, R², R³, R⁴ may be substituted with R⁵, wherein R⁵ represents hydrogen, halogen, hydroxy, formyl, carboxy and salts and esters thereof, amino, nitro, C₁₋₁₂-alkyl, C₁₋₆-alkoxy, carbonyl(C₁₋₁₂-alkyl), aryl, in particular phenyl, sulfo aminosulfonyl, carbamoyl, phosphono, phosphonooxy, and salts and esters thereof.

The enhancing agent may also be a salt or an ester of formula I or II.

Further preferred enhancing agents are oxoderivatives and N-hydroxy derivatives of heterocyclic compounds and oximes of oxo- and formyl-derivatives of heterocyclic compounds, said heterocyclic compounds including five-membered nitrogen-containing heterocycles, in particular pyrrol, pyrazole and imidazole and their hydrogenated counterparts (e.g. pyrrolidine) as well as triazoles, such as 1,2,4-triazole; six-membered nitrogen-containing heterocycles, in particular mono-, di- and triazinanes (such as piperidine and piperazine), morpholine and their unsaturated counterparts (e.g. pyridine and pyrimidine); and condensed heterocycles containing the above heterocycles as substructures, e.g. indole, benzothiazole, quinoline and benzoazepine.

Examples of preferred enhancing agent from these classes of compounds are pyridine aldoximes; N-hydroxypyrrolidinediones such as N-hydroxysuccinimide and N-hydrocyphthalimide; 3,4-dihydro-3-hydroxybenzo[1,2,3]triazine-4-one; formaldoxime trimer (N,N′,N″-trihydroxy-1,3,5-triazinane); and violuric acid (1,3-diazinane-2,4,5,6-tetrone-5-oxime).

Still further enhancing agents which may be used in the invention include oximes of oxo- and formyl-derivatives of aromatic compounds, such as benzoquinone dioxime and salicylaldoxime (2-hydroxybenzaldehyde oxime), and N-hydroxyamides and N-hydroxyanilides, such as N-hydroxyacetanilide.

Preferred enhancing agents are selected from the group consisting of 1-hydroxybenzotriazole; 1-hydroxybenzotriazole hydrate; 1-hydroxybenzotriazole sodium salt; 1-hydroxybenzotriazole potassium salt; 1-hydroxybenzotriazole lithium salt; 1-hydroxybenzotriazole ammonium salt; 1-hydroxybenzotriazole calcium salt; 1-hydroxybenzotriazole magnesium salt; and 1-hydroxybenzotriazole-6-sulphonic acid.

A particularly preferred enhancing agent is 1-hydroxybenzotriazole.

All the specifications of N-hydroxy compounds above are understood to include tautomeric forms such as N-oxides whenever relevant.

Another preferred group of enhancing agents comprises a —CO—NOH— group and has the general formula III:

in which A is:

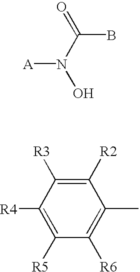

or B is H or C₁₋₁₂-alkyl, said alkyl may contain hydroxy, ester or ether groups (e.g. wherein the ether oxygen is directly attached to A—N(OH)C═O—, thus including N-hydroxy carbamic acid ester derivatives), and R2, R3, R4, R5 and R6 independently of each other are H, OH, NH₂, COOH, SO₃H, C₁₋₈-alkyl, acyl, NO₂, CN, Cl, Br, F, CF₃, NOH—CO-phenyl, CO—NOH-phenyl, C₁₋₆—CO—NOH—A, CO—NOH—A, COR12, phenyl-CO—NOH—A, OR7, NR8R9, COOR10, or NOH—CO—R11, wherein R7, R8, R9, R10, R11 and R12 are C₁₋₁₂-alkyl or acyl.

R2, R3, R4, R5 and R6 of A are preferably H, OH, NH₂, COOH, SO₃H, C₁₋₃-alkyl, acyl, NO₂, CN, Cl, Br, F, CF₃, NOH—CO-phenyl, CO—NOH-phenyl, COR12, OR7, NR8R9, COOR10, or NOH—CO—R11, wherein R7, R8 and R9 are C₁₋₃-alkyl or acyl, and R10, R11 and R12 are C₁₋₃-alkyl; more preferably R2, R3, R4, R5 and R6 of A are H, OH, NH₂, COOH, SO₃H, CH₃, acyl, NO₂, CN, Cl, Br, F, CF₃, CO—NOH-phenyl, COCH₃, OR7, NR8R9, or COOCH₃, wherein R7, R8 and R9 are CH₃ or COCH₃; even more preferably R2, R3, R4, R5 and R6 of A are H, OH, COOH, SO₃H, CH₃, acyl, NO₂, CN, Cl, Br, F, CO—NOH-phenyl, OCH₃, COCH₃, or COOCH₃; and in particular R2, R3, R4, R5 and R6 of A are H, OH, COOH, SO₃H, CH₃, NO₂, CN, Cl, Br, CO—NOH-phenyl, or OCH₃.

R2, R3, R4, R5 and R6 of B are preferably H, OH, NH₂, COOH, SO₃H, C₁₋₃-alkyl, acyl, NO₂, CN, Cl, Br, F, CF₃, NOH—CO-phenyl, CO—NOH-phenyl, COR12, OR7, NR8R9, COOR10, or NOH—CO—R11, wherein R7, R8 and R9 are C₁₋₃-alkyl or acyl, and R10, R11 and R12 are C₁₋₃-alkyl; more preferably R2, R3, R4, R5 and R6 of B are H, OH, NH₂, COOH, SO₃H, CH₃, acyl, NO₂, CN, Cl, Br, F, CF₃, CO—NOH-phenyl, COCH₃, OR7, NR8R9, or COOCH₃, wherein R7, R8 and R9 are CH₃ or COCH₃; even more preferably R2, R3, R4, R5 and R6 of B are H, OH, COOH, SO₃H, CH₃, acyl, NO₂, CN, Cl, Br, F, CO—NOH-phenyl, OCH₃, COCH₃, or COOCH₃; and in particular R2, R3, R4, R5 and R6 of B are H, OH, COOH, SO₃H, CH₃, NO₂, CN, Cl, Br, CO—NOH-phenyl, or OCH₃.

B is preferably H or C₁₋₃-alkyl, said alkyl may contain hydroxy, ester or ether groups; preferably said alkyl may contain ester or ether groups; more preferably said alkyl may contain ether groups.

In an embodiment, A and B independently of each other are:

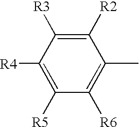

or B is H or C₁₋₃-alkyl, said alkyl may contain hydroxy, ester or ether groups (e.g. wherein the ether oxygen is directly attached to A—N(OH)C═O—, thus including N-hydroxy carbamic acid ester derivatives), and R2, R3, R4, R5 and R6 independently of each other are H, OH, NH₂, COOH, SO₃H, C₁₋₃-alkyl, acyl, NO₂, CN, Cl, Br, F, CF₃, NOH—CO-phenyl, CO—NOH-phenyl, COR12, OR7, NR8R9, COOR10, or NOH—CO—R11, wherein R7, R8 and R9 are C₁₋₃-alkyl or acyl, and R10, R11 and R12 are C₁₋₃-alkyl.

In another embodiment, A and B independently of each other are:

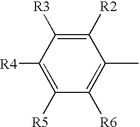

or B is H or C₁₋₃-alkyl, said alkyl may contain hydroxy or ether groups (e.g. wherein the ether oxygen is directly attached to A—N(OH)C═O—, thus including N-hydroxy carbamic acid ester derivatives), and R2, R3, R4, R5 and R6 independently of each other are H, OH, NH₂, COOH, SO₃H, CH₃, acyl, NO₂, CN, Cl, Br, F, CF₃, CO—NOH-phenyl, COCH₃, OR7, NR8R9, or COOCH₃, wherein R7, R8 and R9 are CH₃ or COCH₃.

In another embodiment, A and B independently of each other are:

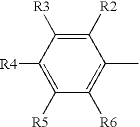

or B is H or C₁₋₃-alkyl, said alkyl may contain hydroxy or ether groups (e.g. wherein the ether oxygen is directly attached to A—N(OH)C═O—, thus including N-hydroxy carbamic acid ester derivatives), and R2, R3, R4, R5 and R6 independently of each other are H, OH, COOH, SO₃H, CH₃, acyl, NO₂, CN, Cl, Br, F, CO—NOH-phenyl, OCH₃, COCH₃, or COOCH₃.

In another embodiment, A and B independently of each other are:

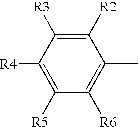

or B is C₁₋₃-alkyl, said alkyl may contain ether groups (e.g. wherein the ether oxygen is directly attached to A—N(OH)C═O—, thus including N-hydroxy carbamic acid ester derivatives), and R2, R3, R4, R5 and R6 independently of each other are H, OH, COOH, SO₃H, CH₃, NO₂, CN, Cl, Br, CO—NOH-phenyl, or OCH₃.

The terms “C₁₋ₙ-alkyl” wherein n can be from 2 through 12, as used herein, represent a branched or straight alkyl group having from one to the specified number of carbon atoms. Typical C₁₋₆-alkyl groups include, but are not limited to, methyl, ethyl, n-propyl, iso-propyl, butyl, iso-butyl, sec-butyl, tert-butyl, pentyl, iso-pentyl, hexyl, iso-hexyl and the like.

The term “acyl” as used herein refers to a monovalent substituent comprising a C₁₋₆-alkyl group linked through a carbonyl group; such as e.g. acetyl, propionyl, butyryl, isobutyryl, pivaloyl, valeryl, and the like.

In an embodiment at least one of the substituents R2, R3, R4, R5 and R6 of A are H, preferably at least two of the substituents R2, R3, R4, R5 and R6 of A are H, more preferably at least three of the substituents R2, R3, R4, R5 and R6 of A are H, most preferably at least four of the substituents R2, R3, R4, R5 and R6 of A are H, in particular all of R2, R3, R4, R5 and R6 of A are H.

In another embodiment at least one of the substituents R2, R3, R4, R5 and R6 of B are H, preferably at least two of the substituents R2, R3, R4, R5 and R6 of B are H, more preferably at least three of the substituents R2, R3, R4, R5 and R6 of B are H, most preferably at least four of the substituents R2, R3, R4, R5 and R6 of B are H, in particular all of R2, R3, R4, R5 and R6 of B are H.

In particular embodiments according to the invention the enhancing agent is selected from the group consisting of

4-nitrobenzoic acid-N-hydroxyanilide;

4-methoxybenzoic acid-N-hydroxyanilide;

N,N′-dihydroxy-N,N′-diphenylterephthalamide;

decanoic acid-N-hydroxyanilide;

N-hydroxy-4-cyanoacetanilide;

N-hydroxy-4-acetylacetanilide;

N-hydroxy-4-hydroxyacetanilide;

N-hydroxy-3-(N′-hydroxyacetamide)acetanilide;

4-cyanobenzoic acid-N-hydroxyanilide;

N-hydroxy-4-nitroacetanilide;

N-hydroxyacetanilide;

N-hydroxy-N-phenyl-carbamic acid isopropyl ester;

N-hydroxy-N-phenyl-carbamic acid methyl ester;

N-hydroxy-N-phenyl-carbamic acid phenyl ester;

N-hydroxy-N-phenyl-carbamic acid ethyl ester; and

N-hydroxy-N-(4-cyanophenyl)-carbamic acid methyl ester.

Another group of preferred enhancing agents is phenolic compounds (alkylsyringates) of the general formula IV:

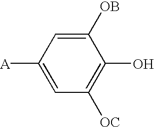

wherein the letter A in said formula denotes be a group such as —D, —CH═CH—D, —CH═CH—CH═CH—D, —CH═N—D, —N═N—D, or —N═CH—D, in which D is selected from the group consisting of —CO—E, —SO₂—E, —N—XY, and —N⁺—XYZ, in which E may be —H, —OH, —R, or —OR, and X and Y and Z may be identical or different and selected from —H and —R; R being a C₁-C₁₆ alkyl, preferably a C₁-C₈ alkyl, which alkyl may be saturated or unsaturated, branched or unbranched and optionally substituted with a carboxy, sulpho or amino group; and B and C may be the same or different and selected from CₘH₂ₘ₊₁, where m=1, 2, 3, 4 or 5.

In the above mentioned general formula IV, A may be placed meta to the hydroxy group instead of being placed in the para-position as shown.

In particular embodiments of the invention the enhancing agent is selected from the group having the general formula V:

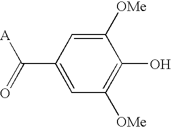

in which A is a group such as —H, —OH, —CH₃, —OCH₃, —O(CH₂)ₙCH₃, where n=1, 2, 3, 4, 5, 6, 7, or 8.

Yet another group of preferred enhancing agents are the compounds as described in general formula VI:

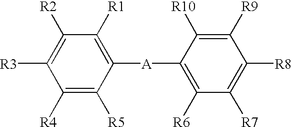

in which general formula A represents a single bond, or one of the following groups: (—CH₂—), (—CH═CH—), (—NR11—), (—CH═N—), (—N═N—), (—CH═N—N═CH—), or (>C═O); and

in which general formula the substituent groups R1-R11, which may be identical or different, independently represents any of the following radicals: hydrogen, halogen, hydroxy, formyl, acetyl, carboxy and esters and salts hereof, carbamoyl, sulfo and esters and salts hereof, sulfamoyl, methoxy, nitro, amino, phenyl, C₁₋₈-alkyl;

which carbamoyl, sulfamoyl, phenyl, and amino groups may furthermore be unsubstituted or substituted once or twice with a substituent group R12; and which C₁₋₈-alkyl group may be saturated or unsaturated, branched or unbranched, and may furthermore be unsubstituted or substituted with one or more substituent groups R12;

which substituent group R12 represents any of the following radicals: hydrogen, halogen, hydroxy, formyl, acetyl, carboxy and esters and salts hereof, carbamoyl, sulfo and esters and salts hereof, sulfamoyl, methoxy, nitro, amino, phenyl, or C₁₋₈-alkyl; which carbamoyl, sulfamoyl, and amino groups may furthermore be unsubstituted or substituted once or twice with hydroxy or methyl.

and in which general formula R5 and R6 may together form a group —B—, in which B represents a single bond, one of the following groups (—CH₂—), (—CH═CH—), (—CH═N—); or B represents sulfur, or oxygen.

In particular embodiments of the invention the enhancing agent is selected from the group having the general formula VII:

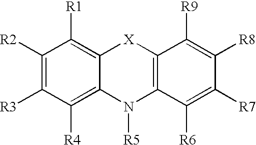

in which general formula X represents a single bond, oxygen, or sulphur; and

in which general formula the substituent groups R1-R9, which may be identical or different, independently represents any of the following radicals: hydrogen, halogen, hydroxy, formyl, acetyl, carboxy and esters and salts hereof, carbamoyl, sulfo and esters and salts hereof, sulfamoyl, methoxy, nitro, amino, phenyl, C₁₋₈-alkyl;

which carbamoyl, sulfamoyl, phenyl, and amino groups may furthermore be unsubstituted or substituted once or twice with a substituent group R10; and which C₁₋₈-alkyl group may be saturated or unsaturated, branched or unbranched, and may furthermore be unsubstituted or substituted with one or more substituent groups R10;

which substituent group R10 represents any of the following radicals: hydrogen, halogen, hydroxy, formyl, acetyl, carboxy and esters and salts hereof, carbamoyl, sulfo and esters and salts hereof, sulfamoyl, methoxy, nitro, amino, phenyl, or C₁₋₈-alkyl; which carbamoyl, sulfamoyl, and amino groups may furthermore be unsubstituted or substituted once or twice with hydroxy or methyl.

Antimicrobial Activity

The composition of the invention may be capable of reducing the number of living cells (killing) of E. coli (DSM1576) to less than 95% (preferably less than 90%, more preferably less than 75%, most preferably less than 50%), when incubated 10 min. at 20° C. in an aqueous solution containing 1 mg/L of the composition.

The composition may also be capable of increasing the time before outgrowth (inhibiting) of E. coli (DSM1576) at 25° C. in a microbial growth substrate containing 1 mg/L of the composition by at least 5%, preferably at least 10%, more preferably at least 25%, and most preferably at least 50%.

We have observed that an improved antimicrobial activity may be obtained by including an enhancing agent in the composition of the invention. Preferably the enhancing agent is an amine compound, which may be a compound of the following formula:

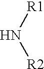

wherein the substituent groups R1 and R2, which may be identical or different, represent any of the following radicals: hydrogen, phenyl, and C₁₋₈-alkyl;

which phenyl and C₁₋₈-alkyl groups may be unsubstituted or substituted with one or more independent substituent groups R3;

which substituent group R3 represents any of the following radicals: hydroxy, halogen, formyl, carboxy and esters and salts thereof, carbamoyl, sulfo and esters and salts thereof, sulfamoyl, nitro, amino, phenyl, acyl, C₁₋₆-alkyl, and C₁₋₆-alkoxy;

which carbamoyl, sulfamoyl, amino, phenyl, C₁₋₆-alkyl, C₁₋₆-alkoxy and acyl groups may furthermore be unsubstituted or substituted with one or more independent substituent groups R4;

which substituent group R4 represents any of the following radicals: halogen, hydroxy, formyl, carboxy and esters and salts thereof, carbamoyl, sulfo and esters and salts thereof, sulfamoyl, nitro, amino, phenyl, acyl, C₁₋₆-alkyl, and C₁₋₆-alkoxy;

which carbamoyl, sulfamoyl, and amino groups may furthermore be unsubstituted or substituted independently once or twice with hydroxy, C₁₋₄-alkyl and C₁₋₄-alkoxy; and

which phenyl, C₁₋₆-alkyl, C₁₋₆-alkoxy and acyl groups may furthermore be unsubstituted or substituted independently with one or more of the following groups: halogen, hydroxy, amino, formyl, carboxy and esters and salts thereof, carbamoyl, sulfo and esters and salts thereof, and sulfamoyl.

The term “C₁₋ₙ-alkyl” wherein n can be from 2 through 8, as used herein, represents a saturated or unsaturated, and branched or straight alkyl group having from one to the specified number of carbon atoms (n). Typical C₁₋₆-alkyl groups include, but are not limited to, methyl, ethyl, ethenyl (vinyl), n-propyl, isopropyl, propenyl, isopropenyl, butyl, isobutyl, sec-butyl, tert-butyl, crotyl, methallyl, pentyl, isopentyl, propenyl, prenyl, hexyl, isohexyl, and the like.

The term “C₁₋ₙ-alkoxy” wherein n can be from 2 through 6, as used herein, represents a C₁₋ₙ-alkyl group linked through an ether group; such as methoxy, ethoxy, propoxy, isopropoxy, butoxy, isobutoxy, sec-butoxy, tert-butoxy, pentoxy, and the like.

The term “acyl” as used herein refers to a monovalent substituent comprising a C₁₋₆-alkyl group linked through a carbonyl group; such as acetyl, propionyl, butyryl, isobutyryl, pivaloyl, valeryl, and the like.

As used herein, the amine compounds may be in their cationic form.

In a preferred embodiment R1 is hydrogen.

In another preferred embodiment R1 is hydrogen and R2 is an alcohol (amino alcohol), e.g., ethanolamine.

In a further preferred embodiment the amine compound is an ammonium salt, i.e. any ammonium salt known in the art: e.g., diammonium sulphate, ammonium chloride, ammonium bromide, or ammonium iodide.

The enhancing agent may be present in the composition in a concentration in the range of 0.01-1000 mM, preferably in the range of 0.05-500 mM, more preferably in the range of 0.1-100 mM, and most preferably in the range of 0.1-50 mM.

Methods and Uses

The present invention provides a method for oxidizing an organic compound, comprising contacting the organic compound with the enzymatic composition of the invention.

The organic compound may be any organic compound susceptible of oxidation. The result of the oxidation may be another (oxidized) organic compound, or it may be two or more compounds, which are the results of a disintegration of the original organic compound. The organic compound may be oxidized as part of an organic synthesis.

The invention also provides a method for modifying the color associated with a dye or colored compound, comprising contacting the dye or colored compound with the enzymatic composition of the invention. “Modifying the color” includes changing the color to another color, such as bleaching (whitening) the color.

The dye or colored compound may be a dye or colored compound in a solution (sollubilized in a solvent), or it may be a dye or colored compound in a dispersion (dispersed in a liquid). The dye or colored compound may also be a solid dye or colored compound, such as a dye or colored compound attached to a hard surface (e.g. a textile material). The dye or colored compound may be a natural (such as lignin or indigo) or a synthetic dye (such as reactive dyes, disperse dyes, sulphur dyes, or vat dyes).

In an embodiment, the method for modifying the color associated with a dye or colored compound is a method for dye-transfer-inhibition (DTI).

The invention also provides a method for killing or inhibiting microbial cells comprising contacting said microbial cells with the enzymatic composition of the invention. In an embodiment the microbial cells include spores.

The composition of the invention is typically useful at any locus subject to contamination by bacteria, fungi, yeast, spores or algae. Typically, loci are in aqueous systems such as cooling water systems, laundry rinse water, oil systems such as cutting oils, lubricants, oil fields and the like, where microorganisms need to be killed or where their growth needs to be controlled. However, the present invention may also be used in all applications for which known antimicrobial compositions are useful, such as protection of wood, latex, adhesive, glue, paper, cardboard, textile, leather, plastics, caulking, and feed.

Other uses include preservation of foods, beverages, cosmetics such as lotions, creams, gels, ointments, soaps, shampoos, conditioners, antiperspirants, deodorants, mouth wash, contact lens products, enzyme formulations, or food ingredients.

Thus, the composition of the invention may by useful as a disinfectant, e.g., in the treatment of acne, infections in the eye or the mouth, skin infections; in antiperspirants or deodorants; in foot bath salts; for cleaning and disinfection of contact lenses, hard surfaces, teeth (oral care), wounds, bruises and the like.

In general it is contemplated that the composition of the invention is useful for cleaning, disinfecting or inhibiting microbial growth on any hard surface. Examples of surfaces, which may advantageously be contacted with the composition of the invention are surfaces of process equipment used e.g. dairies, chemical or pharmaceutical process plants, water sanitation systems, oil processing plants, paper pulp processing plants, water treatment plants, and cooling towers. The composition of the invention should be used in an amount, which is effective for cleaning, disinfecting or inhibiting microbial growth on the surface in question.

Further, it is contemplated that the composition of the invention can advantageously be used in a cleaning-in-place (C.I.P.) system for cleaning of process equipment of any kind.

The composition of the invention may additionally be used for cleaning surfaces and cooking utensils in food processing plants and in any area in which food is prepared or served such as hospitals, nursing homes, restaurants, especially fast food restaurants, delicatessens and the like. It may also be used as an antimicrobial in food products and would be especially useful as a surface antimicrobial in cheeses, fruits and vegetables and food on salad bars.

It may also be used as a preservation agent or a disinfection agent in water based paints.

The composition of the invention is also useful for microbial control of water lines, and for disinfection of water, in particular for disinfection of industrial water.

The composition may also be used for reducing malodor from various sources, such as from cat litter.

Detergent Composition

The composition of the invention may be added to and thus become a component of a detergent composition.

The detergent composition of the invention may for example be formulated as a hand or machine laundry detergent composition including a laundry additive composition suitable for pre-treatment of stained fabrics and a rinse added fabric softener composition, or be formulated as a detergent composition for use in general household hard surface cleaning operations, or be formulated for hand or machine dishwashing operations.

In a specific aspect, the invention provides a detergent additive comprising the composition of the invention and a surfactant. The detergent additive as well as the detergent composition may comprise one or more other enzymes such as a protease, a lipase, a cutinase, an amylase, a carbohydrase, a cellulase, a pectinase, a mannanase, an arabinase, a galactanase, a xylanase, an oxidase, e.g., a laccase, and/or a peroxidase.

In general the properties of the chosen enzyme(s) should be compatible with the selected detergent, (i.e. pH-optimum, compatibility with other enzymatic and non-enzymatic ingredients, etc.), and the enzyme(s) should be present in effective amounts.

Proteases: Suitable proteases include those of animal, vegetable or microbial origin. Microbial origin is preferred. Chemically modified or protein engineered mutants are included. The protease may be a serine protease or a metallo protease, preferably an alkaline microbial protease or a trypsin-like protease. Examples of alkaline proteases are subtilisins, especially those derived from Bacillus, e.g., subtilisin Novo, subtilisin Carlsberg, subtilisin 309, subtilisin 147 and subtilisin 168 (described in WO 89/06279). Examples of trypsin-like proteases are trypsin (e.g. of porcine or bovine origin) and the Fusarium protease described in WO 89/06270 and WO 94/25583.

Examples of useful proteases are the variants described in WO 92/19729, WO 98/20115, WO 98/20116, and WO 98/34946, especially the variants with substitutions in one or more of the following positions: 27, 36, 57, 76, 87, 97, 101, 104, 120, 123, 167, 170, 194, 206, 218, 222, 224, 235 and 274.

Preferred commercially available protease enzymes include Alcalase™, Savinase™, Primase™, Everlase™, Esperase™, and Kannase™ (Novozymes A/S), Maxatase™, Maxacal™, Maxapem™, Properase™, Purafect™, Purafect OxP™, FN2™, and FN3™ (Genencor International Inc.).

Lipases: Suitable lipases include those of bacterial or fungal origin. Chemically modified or protein engineered mutants are included. Examples of useful lipases include lipases from Humicola (synonym Thermomyces), e.g. from H. lanuginosa (T. lanuginosus) as described in EP 258 068 and EP 305 216 or from H. insolens as described in WO 96/13580, a Pseudomonas lipase, e.g. from P. alcaligenes or P. pseudoalcaligenes (EP 218 272), P. cepacia (EP 331 376), P. stutzeri (GB 1,372,034), P. fluorescens, Pseudomonas sp. strain SD 705 (WO 95/06720 and WO 96/27002), P. wisconsinensis (WO 96/12012), a Bacillus lipase, e.g. from B. subtilis (Dartois et al. (1993), Biochemica et Biophysica Acta, 1131, 253-360), B. stearothermophilus (JP 64/744992) or B. pumilus (WO 91/16422).

Other examples are lipase variants such as those described in WO 92/05249, WO 94/01541, EP 407 225, EP 260 105, WO 95/35381, WO 96/00292, WO 95/30744, WO 94/25578, WO 95/14783, WO 95/22615, WO 97/04079 and WO 97/07202.

Preferred commercially available lipase enzymes include Lipolase™, Lipolase Ultra™ and Lipoprime™ (Novozymes A/S).

Amylases: Suitable amylases (α and/or β) include those of bacterial or fungal origin. Chemically modified or protein engineered mutants are included. Amylases include, for example, α-amylases obtained from Bacillus, e.g. a special strain of B. licheniformis, described in more detail in GB 1,296,839.

Examples of useful amylases are the variants described in WO 94/02597, WO 94/18314, WO 96/23873, and WO 97/43424, especially the variants with substitutions in one or more of the following positions: 15, 23, 105, 106, 124, 128, 133, 154, 156, 181, 188, 190, 197, 202, 208, 209, 243, 264, 304, 305, 391, 408, and 444.

Commercially available amylases are Duramyl™, Termamyl™, Fungamyl™ and BAN™ (Novozymes A/S), Rapidase™ and Purastar™ (Genencor International Inc.).

Cellulases: Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g. the fungal cellulases produced from Humicola insolens, Myceliophthora thermophila and Fusarium oxysporum disclosed in U.S. Pat. Nos. 4,435,307, 5,648,263, 5,691,178, 5,776,757 and WO 89/09259.

Especially suitable cellulases are the alkaline or neutral cellulases having colour care benefits. Examples of such cellulases are cellulases described in EP 0 495 257, EP 0 531 372, WO 96/11262, WO 96/29397, WO 98/08940. Other examples are cellulase variants such as those described in WO 94/07998, EP 0 531 315, U.S. Pat. Nos. 5,457,046, 5,686,593, 5,763,254, WO 95/24471, WO 98/12307 and PCT/DK98/00299.

Commercially available cellulases include Celluzyme™, and CarezymeT™ (Novozymes A/S), Clazinase™, and Puradax HA™ (Genencor International Inc.), and KAC-500(B)™ (Kao Corporation).

Peroxidases/Oxidases: Suitable peroxidases/oxidases include those of plant, bacterial or fungal origin. Chemically modified or protein engineered mutants are included. Examples of useful peroxidases include peroxidases from Coprinus, e.g. from C. cinereus, and variants thereof as those described in WO 93/24618, WO 95/10602, and WO 98/15257.

The detergent enzyme(s) may be included in a detergent composition by adding separate additives containing one or more enzymes, or by adding a combined additive comprising all of these enzymes. A detergent additive of the invention, i.e. a separate additive or a combined additive, can be formulated e.g. as a granulate, a liquid, a slurry, etc. Preferred detergent additive formulations are granulates, in particular non-dusting granulates, liquids, in particular stabilized liquids, or slurries.

Non-dusting granulates may be produced, e.g., as disclosed in U.S. Pat. Nos. 4,106,991 and 4,661,452 and may optionally be coated by methods known in the art. Examples of waxy coating materials are poly(ethylene oxide) products (polyethyleneglycol, PEG) with mean molar weights of 1000 to 20000; ethoxylated nonylphenols having from 16 to 50 ethylene oxide units; ethoxylated fatty alcohols in which the alcohol contains from 12 to 20 carbon atoms and in which there are 15 to 80 ethylene oxide units; fatty alcohols; fatty acids; and mono- and di- and triglycerides of fatty acids. Examples of film-forming coating materials suitable for application by fluid bed techniques are given in GB 1483591. Liquid enzyme preparations may, for instance, be stabilized by adding a polyol such as propylene glycol, a sugar or sugar alcohol, lactic acid or boric acid according to established methods. Protected enzymes may be prepared according to the method disclosed in EP 238,216.

The detergent composition of the invention may be in any convenient form, e.g., a bar, a tablet, a powder, a granule, a paste or a liquid. A liquid detergent may be aqueous, typically containing up to 70% water and 0-30% organic solvent, or non-aqueous.

The detergent composition comprises one or more surfactants, which may be non-ionic including semi-polar and/or anionic and/or cationic and/or zwitterionic. The surfactants are typically present at a level of from 0. 1% to 60% by weight.

When included therein the detergent will usually contain from about 1% to about 40% of an anionic surfactant such as linear alkylbenzenesulfonate, alpha-olefinsulfonate, alkyl sulfate (fatty alcohol sulfate), alcohol ethoxysulfate, secondary alkanesulfonate, alpha-sulfo fatty acid methyl ester, alkyl- or alkenylsuccinic acid or soap.

When included therein the detergent will usually contain from about 0.2% to about 40% of a non-ionic surfactant such as alcohol ethoxylate, nonylphenol ethoxylate, alkylpolyglycoside, alkyldimethylamineoxide, ethoxylated fatty acid monoethanolamide, fatty acid monoethanolamide, polyhydroxy alkyl fatty acid amide, or N-acyl N-alkyl derivatives of glucosamine (“glucamides”).

The detergent may contain 0-65% of a detergent builder or complexing agent such as zeolite, diphosphate, triphosphate, phosphonate, carbonate, citrate, nitrilotriacetic acid, ethylenediaminetetraacetic acid, diethylenetriaminepentaacetic acid, alkyl- or alkenylsuccinic acid, soluble silicates or layered silicates (e.g. SKS-6 from Hoechst).

The detergent may comprise one or more polymers. Examples are carboxymethylcellulose, poly(vinylpyrrolidone), poly (ethylene glycol), poly(vinyl alcohol), poly(vinylpyridine-N-oxide), poly(vinylimidazole), polycarboxylates such as polyacrylates, maleic/acrylic acid copolymers and lauryl methacrylate/acrylic acid copolymers.

The detergent may contain a bleaching system which may comprise a H202 source such as perborate or percarbonate which may be combined with a peracid-forming bleach activator such as tetraacetylethylenediamine or nonanoyloxybenzenesulfonate. Alternatively, the bleaching system may comprise peroxyacids of e.g. the amide, imide, or sulfone type.

The enzyme(s) of the detergent composition of the invention may be stabilized using conventional stabilizing agents, e.g., a polyol such as propylene glycol or glycerol, a sugar or sugar alcohol, lactic acid, boric acid, or a boric acid derivative, e.g., an aromatic borate ester, or a phenyl boronic acid derivative such as 4-formylphenyl boronic acid, and the composition may be formulated as described in e.g. WO 92/19709 and WO 92/19708.

The detergent may also contain other conventional detergent ingredients such as e.g. fabric conditioners including clays, foam boosters, suds suppressors, anti-corrosion agents, soil-suspending agents, anti-soil redeposition agents, dyes, bactericides, optical brighteners, hydrotropes, tarnish inhibitors, or perfumes.

It is at present contemplated that in the detergent compositions any enzyme, in particular the haloperoxidase of the composition of the invention, may be added in an amount corresponding to 0.01-100 mg of enzyme protein per liter of wash liquor, preferably 0.05-10 mg of enzyme protein per liter of wash liquor, more preferably 0.1-5 mg of enzyme protein per liter of wash liquor, and most preferably 0.1-1 mg of enzyme protein per liter of wash liquor.

The composition of the invention may additionally be incorporated in the detergent formulations disclosed in WO 97/07202 which is hereby incorporated as reference.

The present invention is further illustrated in the following examples, which are not in any way intended to limit the scope of the invention as claimed.

### EXAMPLES

The chemicals used in the following examples were commercial products of at least reagent grade.

The Malthus Flexi M2060 instrument is available from Malthus Instruments Limited, England.

The Curvularia verruculosa recombinant haloperoxidase is available from Novozymes A/S, Denmark.

Brain Heart Infusion Broth (#CM225) and Tryptone Soya Agar (#CM129) is available from Oxoid, England.

CFU/ml: Colony Forming Units per ml.

Determination of Antimicrobial Activity

Antimicrobial activity may be measured in terms of the number of log reductions. The term “log reduction” is defined as a logarithmic reduction of the number of living cells, e.g. 1 log reduction corresponds to a reduction in living cell number of Escherichia coli DSM1576 or Enterococcus faecalis DSM2570 from Y×10^{X} CFU/M (CFU: Colony Forming Units, M: ml or g) to Y×10^{X-1} CFU/M, where X can be 1, 2, 3, 4, 5, 6, 7, 8, 9, 10 or 11, and Y can be any number from 0 to 10. The number of living bacteria are to be determined as the number of E. coli or E. faecalis, respectively, which can grow on Tryptone Soya Agar plates at 30° C.

### Example 1

Antimicrobial Activity of a Haloperoxidase, Hydrogen Peroxide, and a Carboxylic Acid Against Escherichia coli Cells

The antibacterial activity of a system composed of a haloperoxidase and hydrogen peroxide were tested in a variety of buffers (including both carboxylic acids and other buffer compounds) and pH against Escherichia coli (DSM 1576).

The E. coli cells were grown in Brain Heart Infusion broth (BHI) until stationary growth phase (30° C., 20 hours). The cells were diluted to approximately 10⁶ CFU/ml in an aqueous solution containing hydrogen peroxide (H₂O₂), Curvularia verruculosa haloperoxidase (rCvP), and a buffer compound. Subsequently the solution was incubated in a 96-well MicroWell plate (Nunc A/S, Denmark) at 40° C. in 20 minutes.

After the incubation, 100 μl of the solution was mixed with 3 ml BHI and the antimicrobial activity was determined as a reduction in the number of living bacterial cells by use of conductance measurements (Malthus Flexi M2060, Malthus Instrument Limited) in the growth substrate. The detection times measured by the Malthus instrument were converted to CFU/ml by a calibration curve.

A log CFU/ml reduction of more than 6 units corresponds to 100% bactericidal activity.

TABLE 1
Antibacterial effect of a system composed of haloperoxidase,
hydrogen peroxide and a buffer compound (carboxylic acids
or other compounds).

| | Buffer | | RCvP | H₂O₂ | Log |
|---|---|---|---|---|---|
| Buffer Compound | conc. | pH | (mg/L) | (mM) | CFU/ml |
| Citric acid [Merck] | 50 mM | 5 | 0.5 | 0.5 | 6.4 |
| Acetic acid [Merck] | 50 mM | 5 | 0.5 | 0.5 | 6.0 |
| 2-(N-morpholino) ethanesulfonic | 50 mM | 6 | 0.5 | 0.5 | 0.6 |
| acid (MES) [Sigma] | | | | | |
| Dimethylglutaric acid (DMG) | 50 mM | 6 | 0.5 | 0.5 | 6.7 |
| [Sigma] | | | | | |
| Dimethylglutaric acid (DMG) | 50 mM | 7 | 0.1 | 0.25 | 7.3 |
| [Sigma] | | | | | |
| KH₂PO₄ [Merck] | 50 mM | 7 | 0.1 | 0.25 | 0.3 |
| HEPES [Sigma H3375] | 50 mM | 7 | 0.1 | 0.25 | 0.7 |
| Tris(hydroxymethyl)amino- | 50 mM | 7 | 0.1 | 0.25 | 0.3 |
| methane (TRIS) [Sigma] | | | | | |
| HEPES [Sigma H3375] | 50 mM | 8 | 1 | 1 | 0.6 |
| Tris(hydroxymethyl)amino- | 50 mM | 8 | 1 | 1 | 0.5 |
| methane (TRIS) [Sigma] | | | | | |
| KH₂PO₄ [Merck] | 50 mM | 8 | 1 | 1 | 0.4 |

From table 1 it can be seen, that when the buffer is a carboxylic acid, such as citric acid, acetic acid, or dimethylglutaric acid, a 100% bactericidal activity is obtained.

1. A composition comprising (a) a haloperoxidase; (b) a source of hydrogen peroxide; and (c) a source of a carboxylic acid.

2. The composition of claim 1, which contains less than 1 mM of a halide.

3. The composition of claim 1, which contains less than 1 mM of an amino acid.

4. The composition of claim 1, further comprising (d) an enhancing agent.

5. A method for oxidizing an organic compound, comprising contacting the organic compound with a composition of claim 1.

6. A method for killing or inhibiting microbial cells, comprising contacting the microbial cells with a composition of claim 1.

7. A method for modifying the color associated with a dye or colored compound, comprising contacting the dye or colored compound with a composition of claim 1.

8. A detergent composition, comprising (a) a haloperoxidase; (b) a source of hydrogen peroxide; (c) a source of a carboxylic acid; and (d) a surfactant.
